(19) United States
(12) Patent Application Publication
(10) Pub. No.: US 2016/0076975 A1
(43) Pub. Date: Mar. 17, 2016

(54) METHOD FOR THE DETECTION AND DIAGNOSIS OF AN OBJECT STATUS AND APPARATUS USING THE METHOD

(71) Applicant: KAI-EE INC., New Taipei City (TW)

(72) Inventor: Chia-Chun HONG, New Taipei City (TW)

(21) Appl. No.: 14/535,058

(22) Filed: Nov. 6, 2014

(30) Foreign Application Priority Data
Sep. 11, 2014 (TW) 103131332

(51) Int. Cl. G01M 99/00

(52) U.S. Cl. CPC G01M 99/00

(57) ABSTRACT

A method for the detection and diagnosis of an object status and apparatus using the method is disclosed. The method includes the step of using a sensor to capture a physical condition, such as temperature, pressure, frequency, wavelength, electrical message or magnetic field of an object, the step of converting the physical condition into a transmittable and computable target information, the step of transmitting the target information to a controller that is capable of obtaining a basic information, and the step of matching the target information with the basic information to obtain a deviation therebetween. Based on the aforesaid technical features, the invention enables the user to directly match, diagnose and analyze the detected data without memorizing or obtaining the standard physical condition of different objects.

### BACKGROUND OF THE INVENTION

1. Field of the Invention

The present invention relates to object status detection method and apparatus and more particularly, to a method for the detection and diagnosis of an object status, which has the functions of detection, real-time matching and information assessment. The invention relates also to an apparatus using the method.

2. Description of the Related Art

In order to let a power machine play its due performance normally and stably, every power machine will set a set of standard specifications for its various mechanical properties. For example, the cylinder pressure of the engine of a power machine must be checked in every maintenance routine to be within the range of the standard value so that the engine can continue long-term operation. If there is a deviation between the measured cylinder pressure and the standard value, the cylinder pressure of the engine must be corrected to avoid engine failure. Further, an electronic equipment can work normally only under a proper operating temperature atmosphere, and therefore the cooling device around the electronic equipment must be regularly measured and controlled so that it can regulate the ambient temperature normally.

However, conventional power machine measuring instruments can simply passively display the measured data. Either an advanced digital measuring instrument or conventional analog measuring instrument is used, the operator needs to know the measured data at first, and then determines the measured data to be or not to be within the normal range subject to personal experience or the original technical manual of the measuring instrument. If the operator cannot obtain the related standard data of the power machine due to lacking in experience or being a non-professional person, the operator will be unable to determine the measured data to be or not to be within the normal range. Moreover, the current measurement methods can simply obtain scattered, independent data, and therefore, they cannot achieve data recording or the function of statistics.

### SUMMARY OF THE INVENTION

The present invention has been accomplished under the circumstances in view. It is the main object of the present invention to provide a method for the detection and diagnosis of an object status and apparatus using the method, which allows the user to directly match, diagnose and analyze the detected data without any prior memory or obtaining the standard physical conditions of different power machines.

To achieve this and other objects of the present invention, a method for the detection and diagnosis of an object status in accordance with the present invention comprises the steps of: using a sensor to capture a physical condition, such as temperature, pressure, frequency, wavelength, electrical message or magnetic field of an object; converting the physical condition into a transmittable and computable target information; transmitting the target information to a controller that is capable of obtaining a basic information; and matching the target information with the basic information to obtain a deviation therebetween. Based on the aforesaid technical features, the invention enables the user to directly match, diagnose and analyze the detected data without memorizing or obtaining the standard physical conditions of different objects.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a block diagram of a preferred embodiment of the present invention.

FIG. 2 is another block diagram of the preferred embodiment of the present invention.

FIG. 3 is an operational flow chart of the preferred embodiment of the present invention.

### DETAILED DESCRIPTION OF THE INVENTION

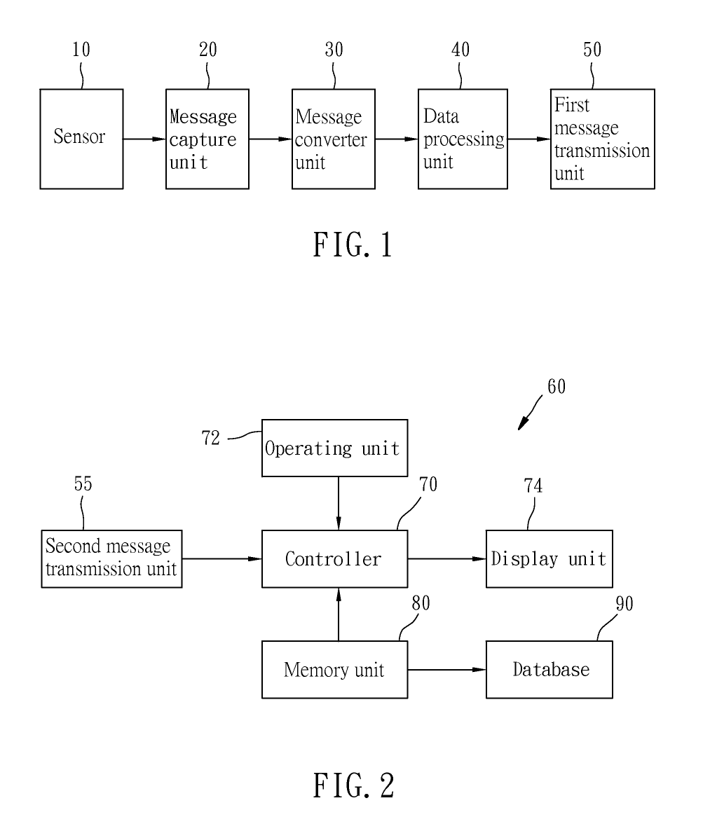

Referring to FIG. 1, an apparatus using a method for the detection and diagnosis of an object status in accordance with the present invention comprises a sensor 10, a message converter unit 30, and a first message transmission unit 50. Preferably, the sensor 10 can obtain the physical condition, such as temperature, pressure, frequency, wavelength, electrical message or magnetic field of an object through a message capture unit 20. The sensor 20 can be installed in any of a variety of instruments or test equipments, enabling the message capture unit 20 to obtain the physical condition of an object either manually or automatically. The object can be any power machine or carrier capable of generating a physical condition.

The message capture unit 20 of the sensor 10 is electrically connected to the message converter unit 30. The message converter unit 30 is adapted to convert the physical condition obtained from the message capture unit 20 into a target information for transfer and computing. In the present preferred embodiment, the message converter unit 30 is an analog/digital converter. The message converter unit 30 is electrically connected to a data processing unit 40. After the message converter unit 30 converted a physical condition into a digital target information, the data processing unit 40 can start a pre-processing procedure to pre-process the digital target information, such as compression, enhancement, noise elimination, enabling the digital target information to be sent out through the first message transmission unit 50 of the data processing unit 40. The signal transmission method of the first message transmission unit 50 can be wired transmission method or wireless transmission method for transmitting the data by, for example, a cable, WiFi or Bluetooth.

The invention further comprises a message receiver system 60 for receiving and assessing signals. The message receiver system 60 comprises a controller 70, an operating unit 72 and a display unit 74 electrically connected to the controller 70 for use as user interfaces for enabling the user to operate the functions of the controller 70, and a memory unit 80 and a database 90 electrically connected to the controller 70. The memory unit 80 is adapted for storing multiple target information. The database 90 can be an individual information storage device, or a cloud database linked through the internet or internet of things. The database 90 has built therein standard basic information corresponding to the physical conditions of the aforesaid object, i.e., the standard specification data of the physical conditions of the various power machines or carriers has been built in the database 90 in advance. Further, the controller 70 is electrically coupled with a second message transmission unit 55 for receiving a target information from the first message transmission unit 50. The second message transmission unit 55 is not limited to a wired signal transmission or wireless signal transmission.

When the apparatus using the method for the detection and diagnosis of an object status in accordance with the present invention transmits a target information through the first message transmission unit 50 to the message receiver system 60, the target information can be computed by the controller 70 and then stored in the memory unit 80. If the sensor 10 obtains different target information at different times or different locations, every target information can be stored and recorded in the memory unit 80, allowing the user to conveniently fetch the actual values of the target information at anytime and to simultaneously track the status of their change.

Further, the controller 70 can match the target information with the corresponding standard basic information in the database 90, obtaining the deviation between the target information and the standard basic information for the determination that the target information is within the range of the standard basic information or not, and thus, the invention provides an object physical condition diagnosis function.

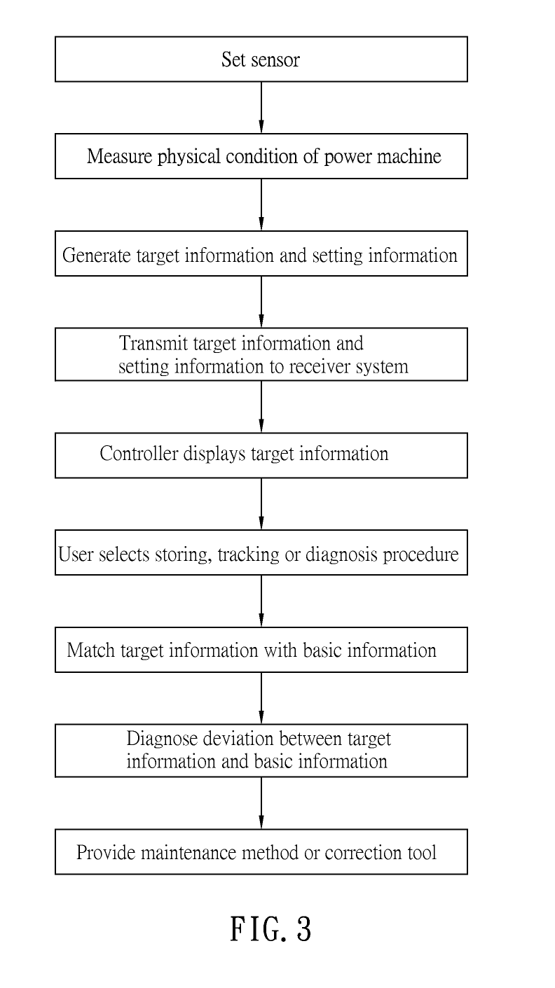

Referring to FIG. 3, the operation of the present invention in a power machine is outlined hereinafter, wherein the power machine can be a vehicle. At first, the user sets the sensor 10 subject to the type, model of the power machine or the physical condition to be detected, enabling the sensor 10 to generate a setting information. Thereafter, the message capture unit 20 is enabled to measure the physical condition. such as pressure value, of the power machine, and then the message converter unit 30 is enabled to convert the pressure value obtained by the message capture unit 20 into a target information for transmission with the setting information to the message receiver system 60. The controller 70 can display the currently measured pressure value on the display unit 74, providing an option for the user to store the measured pressure data or to track or diagnose other different pressure values.

After obtained the target information and the setting information, the controller 70 can obtain the basic information of the corresponding target information from the database 90 according to the setting information, i.e., obtain the standard pressure value of the vehicle been measured, and then start the procedure of matching the target information with the basic information to obtain a deviation therebetween. For example, if the lower limit of the standard pressure value is 25 psi and the pressure value obtained through the message capture unit 20 is 20 psi, the target information will be out of the standard specification of the basic information, and thus, the controller 70 can display the sign of substandard, enabling the user to know the current problem and to further seek solutions.

All physical conditions of the object been measured can be presented by numerical data, enabling the user to know the actual measurement conditions rapidly. More importantly, the user using the present invention can directly match the measured target information with the basic information in the database to make sure that the data is within or not within the standard range without prior memory or obtaining the standard physical condition data of different power machines. If the database is a cloud database of the internet of things, the diversity and technical services of the basic information can be unlimitedly expanded to further provide a variety of maintenance information or correction tools.

Further, different target information measured by different users can be used for making statistical analysis in the database for the purpose of providing users with relevant analytical information, or providing manufacturers to enhance their design or maintenance services.

It's worth mentioning that the invention uses the database to provide basic information of standard specifications, and therefore, using a wired or wireless signal transmission technique to obtain the latest content of the database can continuously provide the latest measurement data, maintaining the measurement accuracy and reliability of the present invention.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An object status detection and diagnosis method, comprising the steps of:
a) using a sensor to capture a physical condition of an object to be detected, said physical condition being selected from the group of temperature, pressure, frequency, wavelength, electrical message and magnetic field;
b) converting said physical condition into a transmittable and computable target information;
c) transmitting said target information to a controller, said controller being capable of obtaining a basic information; and
d) matching said target information with said basic information to obtain a deviation between said target information and said basic information and to further provide relevant measures.

2. The object status detection and diagnosis method as claimed in claim 1, wherein said target information is stored by said controller in a memory unit.

3. The object status detection and diagnosis method as claimed in claim 1, wherein said basic information is built in a database.

4. The object status detection and diagnosis method as claimed in claim 3, wherein said database is a cloud database linkable through the internet or internet of things.

5. The object status detection and diagnosis method as claimed in claim 1, further comprising the step of providing a maintenance or correction information subject to said deviation.

6. The object status detection and diagnosis method as claimed in claim 1, wherein said basic information corresponds to said physical condition of said object.

7. An apparatus using the object status detection and diagnosis method as claimed in claim 1, comprising:
a sensor adapted for obtaining a physical condition of an object, said physical condition being selected from the group of temperature, pressure, frequency, wavelength, electrical message and magnetic field;
a message converter unit for converting said physical condition of said object been obtained by said message capture unit into a transmittable ad computable target information; and
a first message transmission unit for sending out said target information through a wired or wireless transmission method.

8. The apparatus as claimed in claim 7, further comprising a message receiver system, said message receiver system comprising a controller, and a memory unit electrically connected to said controller and adapted for storing a plurality of said target information, and a database electrically connected to said controller, said database having built therein basic information corresponding to said physical condition of said object.

9. The apparatus as claimed in claim 8, wherein said database said database is a cloud database linkable through the internet or internet of things.

10. The apparatus as claimed in claim 8, wherein said controller is electrically connected to an operating unit and a display unit that are used as user interfaces.
